(19) United States
(12) Patent Application Publication
(10) Pub. No.: US 2017/0080686 A1
(43) Pub. Date: Mar. 23, 2017

(54) MULTILAYER PANEL COMPRISING AT LEAST ONE LAYER MADE OF CEMENTITIOUS MATERIAL

(71) Applicant: Italcementi S.P.A., Bergamo (IT)

(72) Inventors: Nicola Rizzo, Bergamo (IT); Aronne Carminati, Chignolo d'Isola (IT)

(21) Appl. No.: 15/311,972

(22) PCT Filed: May 18, 2015
(86) PCT No.: PCT/EP2015/060888

§ 371 Date: Nov. 17, 2016

(30) Foreign Application Priority Data
May 19, 2014 (IT) MI2014A000909

(51) Int. Cl. B32B 13/12; E04C 2/54; E04C 2/26; B32B 7/12; B32B 17/06

(52) U.S. Cl. CPC B32B 13/12; B32B 7/12; B32B 17/06; E04C 2/26; E04C 2/54; B32B 2307/412; B32B 2419/00

(57) ABSTRACT

The object of the present invention is a multilayer panel with light transparency and thermal insulation properties. The panel comprises a first layer (10) made of cementitious material, a second layer (20) made of a transparent material and an intermediate layer (11) made of a thermoplastic material which produces adhesion between the first (10) and the second layer (20).

### CROSS REFERENCE TO RELATED APPLICATIONS

The present application claims priority to PCT International Application No. PCT/EP2015/060888 filed on May 18, 2015, which application claims priority to Italian Patent Application No. MI2014A000909 filed May 19, 2014, the entirety of the disclosures of which are expressly incorporated herein by reference.

### STATEMENT RE: FEDERALLY SPONSORED RESEARCH/DEVELOPMENT

Not Applicable.

Field of the Invention

The present invention falls within the scope of production of cementitious articles. In particular, the object of the present invention is a multilayer panel comprising one layer made of cementitious material and one layer made of light transparent material. The present invention also relates to a method of producing said multilayer panel.

State of the Art

In the course of the last few years, there has been a strong demand, within the planning of buildings and interiors, for new architectural elements capable of combining different kinds of materials such as cementitious and glass materials or cementitious materials and plastic materials, for example These architectural elements include articles in the form of panels, which can be used, for example, as dividing elements between two environments or, which have purely aesthetic and/or decorative purposes.

In the case of the production of panels made of cementitious and glass material for example, the assembly thereof normally provides for the use of a connecting frame (in plastic, wood or metal material) that is fixed to the part made of cementitious material. This frame surrounds and supports the glass element in a manner that is entirely analogous to what is provided in the production of windows and doors. According to an alternative embodiment known that is also known, the parts made of glass or plastic are connected to the part made of cementitious material using screw anchoring or equivalent means that require preliminary operations to prepare the surfaces to be connected. It has been seen that the use of connecting means, such as the ones described above, is surely a critical aspect, above all in the case in which the architectural element has a prevalently aesthetic purpose. Moreover, the use of these means heavily affects costs/completion times and final production costs in that it requires the execution of delicate preparatory operations.

In a known embodiment, the support planes, produced by coupling panels made of cementitious material and glass plates, are obtained in such a way that the part made of glass rests on the cementitious panel either directly or by means of rubber feet arranged in proximity to the corners. In this case, however, the glass is more easily subject to breakage especially if loaded in the central part and does not have a stable anchorage. In fact the part made of glass can move with respect to the part made of cementitious material.

### SUMMARY

The main aim of the present invention is to provide a manufactured article that is at least in part cementitious, that allows the drawbacks of the prior art to be overcome. Whitin this aim, a first object of the present invention is to provide a manufactured article that is at least in part cementitious, wherein different types of materials can be assembled together, without recourse to means that are cumbersome and/or that require costly and complicated operations on said materials: Another object of the present invention is to produce a cementitious item that is reliable and easy to produce at competitive costs.

This aim and these objects are achieved by means of a multilayer panel comprising a first outer face and a second outer face, opposite said first outer face, wherein at least one first layer of the panel is made of cementitious material (including composite material) and wherein at least one second layer of the panel is made of a transparent material. The first layer defines the first outer face of the panel, while the second layer defines the second outer face of the panel itself. The panel according to the invention moreover comprises a first intermediate layer interposed between the first layer and the second layer wherein the intermediate layer is made of a thermoplastic material that achieves adhesion of the first layer to the second layer.

The use of a multilayer panel advantageously allows the drawbacks of the prior art to be overcome. In particular, the junction of the outermost layers of a different type is achieved by means of an intermediate layer without recourse to the mechanical means (frames, screws and the like) normally used in the state of the art. The multilayer panel according to the invention can be indifferently used as an architectural element to, for example, define a dividing wall between two environments, or even as a piece of furniture, it being possible for it to become a support or working plane, for example.

### LIST OF DRAWINGS

Further characteristics and advantages shall become clear from the following detailed description of the method for producing the cementitious article according to the present invention illustrated by way of a non-limiting example by means of the accompanying drawing, wherein:

FIG. 1 is a cross-sectional view relating to a first embodiment of a panel according to the present invention;

FIGS. 2 and 3 are, respectively, an exploded view and a perspective view of the panel of FIG. 1;

FIG. 4 is a cross-sectional view relating to a second embodiment of a panel according to the present invention;

FIGS. 5 and 6 are, respectively, an exploded view and a perspective view of the panel of FIG. 4;

FIG. 7 is a cross-sectional view relating to a third embodiment of a panel according to the present invention;

FIGS. 8 and 9 are, respectively, an exploded view and a perspective view of the panel of FIG. 7;

FIG. 10 is a cross-sectional view relating to a fourth embodiment of a panel according to the present invention;

FIGS. 11 and 12 are, respectively, an exploded view and a perspective view of the panel of FIG. 10;

The same reference numbers and letters in the drawings identify the same elements or components.

### DETAILED DESCRIPTION

The present invention therefore relates to a multilayer panel 1,1′,1″,1′″ which can be used in construction as an architectural element or piece of furniture. The panel 1,1′,1″,1′″ comprises a first outer face 21 and a second outer face 22 opposite said first outer face 21. For the purposes of the present invention the outer faces 21,22 indicate the two faces facing the panel 1,1′,1″,1′″ having greater extension. Preferably such outer faces 21,22 are substantially parallel to each other.

The panel 1,1′,1″,1′″ according to the invention comprises a first layer 10 made of cementitious material which defines the first outer surface 21. The panel 1,1′,1″,1′″ also comprises a second layer 20 made of a light transparent material which defines the second outer surface 22 of the panel. For the purposes of the present invention the first layer 10 and the second layer 20 are the outermost layers of the panel.

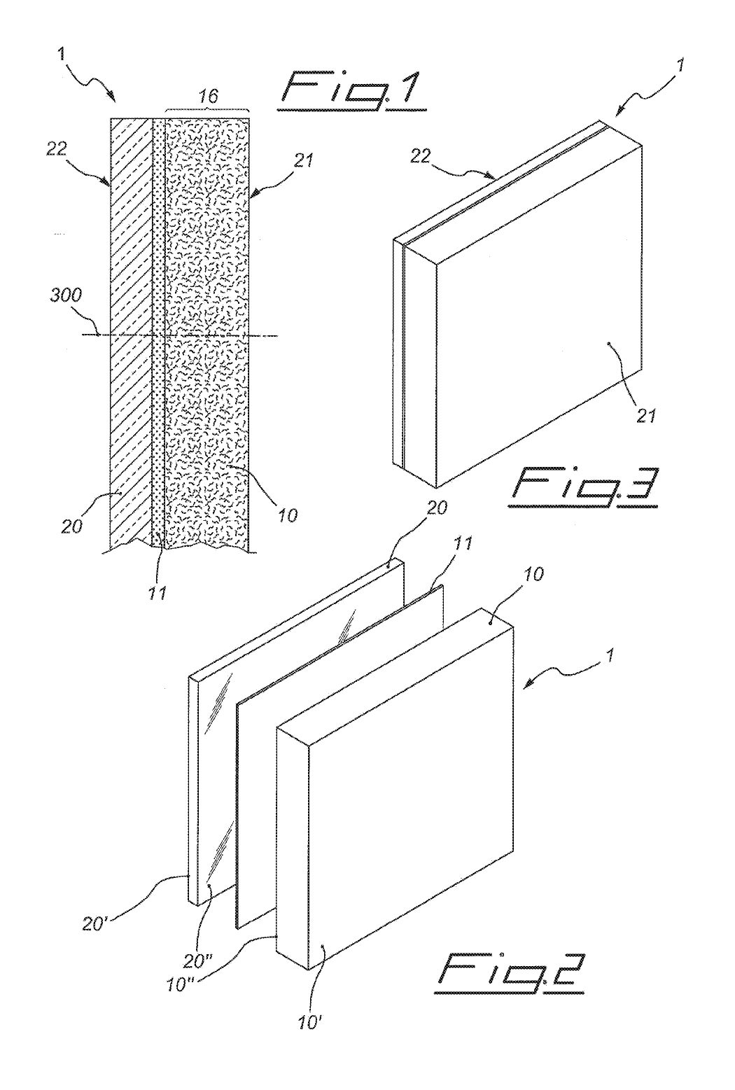

In this regard, the panel 1,1′,1″,1′″ according to the invention comprises at least one intermediate layer 11, preferably but not exclusively, made of a light transparent material and adapted to producing adhesion between the first layer 10 and the second layer 20. As better described below, the intermediate layer 11 is made of a thermoplastic material which has a lower glass transition temperature than that of the material that constitutes the second layer 20 of the panel 1,1′,1″,1′″. Preferably the first layer 10 is formed by a body made of cementitious material with a prismatic shape having a first main surface 10′ and a second main surface 10″ opposite to each other, as indicated in the exploded view of FIG. 2 for example. The first main surface 10′ defines the first outer surface 21 of the panel 1,1′,1″,1′″ once this has been assembled. For the purposes of the present invention, the thickness of the first layer 10 is identified as the distance 16 (indicated only in FIG. 1 for simplicity) between the main surfaces 10′,10″ measured along a reference direction 300 that is orthogonal to the same main surfaces. In general, for the purposes of the present invention, the thickness of any layer 10,11,20 of the panel 1,1′,1″,1′″ is evaluated according to the above-defined reference direction 300.

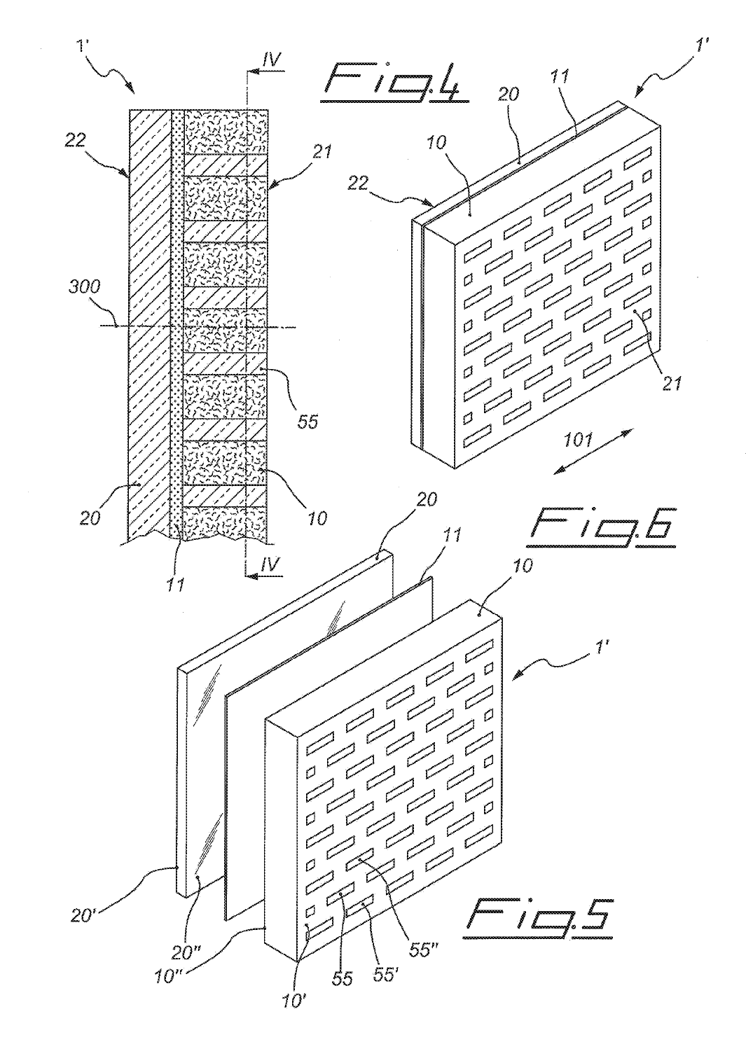

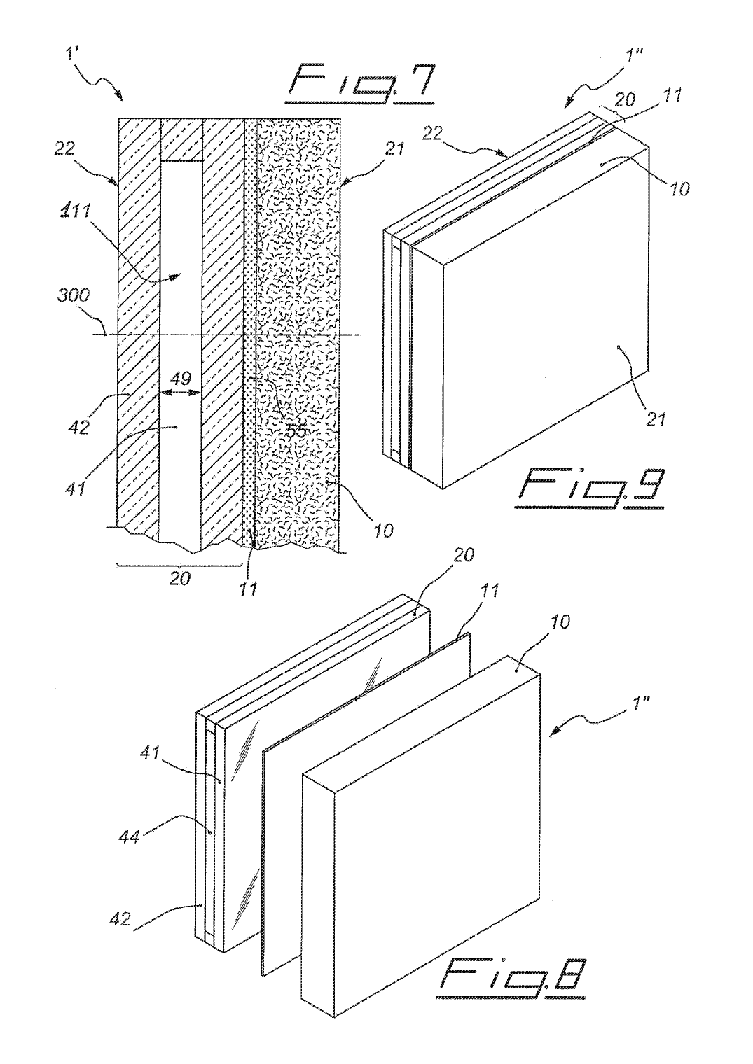

In the embodiment shown in FIGS. 1 to 3 and in the embodiment shown in FIGS. 7 to 9, the body made of cementitious material which defines the first layer 10 has a substantially homogenous configuration. Instead, in the embodiment shown in FIGS. 4 to 6, the first layer 10 comprises inner portions 55,55,55″ which pass through the same first layer 10, through the entire thickness thereof, indeed evaluated with respect to the reference direction 300. These inner portions 55,55,55″ are made of a light transparent material which can be glass or polymethylmethacrylate (PMMA) for example. The exploded view of FIG. 5 allows observation of a possible configuration of the inner portions 55,55,55″ made of transparent material, which are indeed “through portions” of the first layer 10. Such inner portions 55,55,55″ (hereinafter also indicated with the expression “through portions”) preferably have a rectangular section evaluated with respect to a section plane IV-IV indicated in FIG. 4. The through portions 55,55′,55″ are moreover preferably arranged according to rows that are parallel to a first reference direction 101 (indicated in FIG. 6). Again, according to a preferred arrangement, the through portions 55 of any row are arranged is as to be in a staggered position with respect to the through portions 55′,55″ of the rows adjacent to it.

According to the invention, the second layer 20 of the panel 1,1′,1″,1′″ can be constituted by a two-dimensional body in plate form, i.e. comprising two main opposite surfaces 20′,20″ and having a markedly greater extension than that of the other surfaces. The second layer 20 is preferably made of a glass selected from the group consisting of float base glass, extra-clear glass, low-emissivity multilayer glass comprising at least a thermal insulating layer, multilayer glass comprising a reflective insulating layer, multilayer glass comprising a layer of safety glass coupled to a low-emissivity glass, tempered glass, decorative glass, screen printed glass and combinations thereof.

According to an alternative embodiment the second layer 20 can be made of a light transparent plastic material preferably selected from the group consisting of PMMA, PET, PETg, SAN, PS, PVC and combinations thereof.

According to a further embodiment shown in FIGS. 7 to 9, the second layer 20 can also be defined by a double-glazing structure. For the purposes of the present invention the term double-glazing (or double glass) indicates a structure comprising a first glass plate 41 and a second glass plate 42, parallel to the first glass plate 41 between which is interposed a peripheral frame 44 that defines an interspace 111 between the same glass plates 41,42. For the purposes of the present invention, in the case in which a double-glazing structure is envisaged, then the width of the second layer 20 exactly corresponds to the width of the double-glazing itself or to the distance, measured along the reference direction 300, between the outermost surfaces of the two above-indicated glass plates 41,42.

The peripheral frame 44 of the double-glazing is defined by a plurality of elements made, for example, of aluminium or, alternatively, of a low thermal conductivity material, such as the material commercially known by the name TGI® for example, in the case in which thermal insulation properties are required of the panel. The elements of the peripheral frame have a thickness in a range normally between 6 mm and 32 mm. Moreover these can be tubular in shape or be internally hollow. In this case the hollows of the tubular elements can advantageously contain dehydrating salts useful for preventing condensation phenomena inside the interspace externally defined by the elements themselves.

The interspace 111 is externally sealed by means of a sealing substance, preferably by means of a polysulfide sealant. Overall, the glass plates 41,42 and the peripheral frame 44 define a watertight interspace 111 which contains air or possibly a specific chemically inert noble gas (such as argon, krypton xenon or a mixture thereof for example) in the case in which specific thermal and/or acoustic properties are required of panel 1.

As indicated above, panel 1 according to the inventions also comprises an intermediate layer 11 arranged between the first layer 10 and the second layer 20. The intermediate layer 11 is preferably, but not exclusively, made of a light transparent material. In other words, the intermediate layer 11 is made of a plastic material which once subjected to heating above its glass transition temperature, takes on adhesive properties such as to produce adhesion between the first layer 10 and the second layer 20 as will be better described below. As already indicated above, the material constituting the intermediate layer 11 has a lower glass transition temperature than that of the material constituting the second layer 20.

In this regard, a thermoplastic material selected from the group consisting of polyvinyl butyral (PVB), thermoplastic polyurethane (TPU), ethylene vinyl acetate (EVA) and mixtures thereof, is preferably used for the intermediate layer 11. In this regard, it has been seen that the use of PVB is particularly advantageous in the case in which the second layer 20 is made of glass or double-glazing.

FIGS. 1 to 3 relate to a first embodiment of a multilayer panel according to the invention indicated with reference 1. The first layer 10 has a homogenous structure, while the second layer 20 can be made of glass or of a transparent plastic material according to principles already indicated above. An intermediate layer 11 made of a thermoplastic material that is preferably translucent and selected from the above-indicated group of materials is provided in this embodiment.

During assembly of panel 1, the intermediate layer 11 is pressed between the first layer 10 and the second layer 20. This operation, known as mangling, determines a first union between the layers 10,20,11 which is subsequently reinforced by means of a heating step having a controlled temperature and pressure. Indeed, following tis assembly, panel 1 is heated, under pre-established pressure conditions, at a temperature that is greater than the glass transition temperature of the thermoplastic material which forms the intermediate layer 11 until adhesion of the second layer 20 with the first layer 10 is achieved. In other words, following heating at a regulated pressure, the intermediate layer 11 in fact acts as a adhesive layer between the first layer 10 and the second layer 20.

According to a preferred embodiment, the innermost surface 10″ of the first layer 10 and the innermost surface 20″ of the second layer 20, intended for contact with the intermediate layer 11, is defined and/or finished in such a way as to present an arithmetic average surface roughness Ra not greater than 500 nanometres and a curvature not greater than 1500 microns. For the first layer 10 made of cementitious material, these roughness and curvature values can be obtained using the method described in application PCT/EP2012/067762, which is to be considered an integral part of the present description. Alternatively, these roughness and curvature values can be obtained by means of a surface smoothing operation for surfaces once the first layer 10 has been produced.

FIGS. 4 to 6 relate to a second embodiment of a panel according to the invention indicated with reference 1′. This second solution differs from the previous solution in that the first layer 10 comprises inner portions 55,55′,55″ made of light transparent material according to what has already been indicated above. The configuration of the first layer 10 gives panel 1′ light transparent properties. Indeed the light transmission between the outer surfaces 21,22 is achieved by virtue of the inner portions 55,55′,55″ of the first layer 10 and of the transparent materials used for the second layer 20 and of the intermediate layer 11.

The light transparency properties of panel 1′ make it advantageously useful, as a dividing wall between two environments for example. It is at the same time observed that the presence of the second layer 20, made of glass or alternatively of plastic material, increases the thermal insulation and acoustic capacity of panel 1′.

Panel 1′ shown in FIGS. 4 to 6, can be produced according to the aforementioned methods. In this regard, it has been seen that for a panel 1′ having a first layer 10 with a thickness of 2 cm, a second layer 20 made of extra-clear glass with a thickness of 4 mm and an intermediate layer 11 made of PVB with a thickness of 0.3 mm, the mangling operation can be achieved in a furnace having an entry temperature of around 90° C., an internal temperature of between 200 and 220° C. and an exit temperature of around 60° C. The multilayer manufactured article thus obtained can therefore be transferred into an autoclave to be heated at a temperature of around 230° C., at a pressure of around 12 Bars and for a permanence time of around eight hours. Under these conditions, the glass transition temperature of the intermediate layer 11 is exceeded and the consequent change of state thereof produces adhesion between the first layer 10 and the second layer 20.

According to one possible embodiment, the material constituting the intermediate layer 11 can have a different shade of colour than that of the material constituting the portions 55,55′,55″ passing through the cementitious material of the first layer 10. By changing the shade of colour of the intermediate layer 11 with respect to that of the through portions 55,55′,55″ it is advantageously possible to obtain different visual effects without intervening on the manufacturing method of the first layer 10.

FIGS. 7 to 9 relate to a third embodiment of a panel according to the present invention, indicated with reference 1″, which differs from the one in FIGS. 4 to 6 in that the second layer 20 is defined by a double-glazing structure that has already been described in detail above. The use of a double-glazing structure leads to an increase in the thermal and acoustic properties. In this regard, the thermal transmittance U₁ of a first layer 10 of panel 1″, of a given cementitious composition, having a width/thickness of 50 mm, was first individually evaluated. This thermal transmittance U₁ was greater than 4.5 W/m²K. The transmittance of the entire panel 1 comprising the first, previously examined, layer 10 and a second layer 20 formed by a double-glazing structure over a total width of 82 mm, was subsequently evaluated. The transmittance value U₂ was lower than 1.4 W/m²K. Using the same material used for the first layer 10, it has therefore been seen that the use of a double-glazing structure leads to an advantageous reduction of about 70% of the overall thermal transmittance.

It is to be understood that the double-glazing structure could also be used in combination with a first layer 10 with a homogenous internal configuration like the one provided for the embodiment shown in FIGS. 1 to 3.

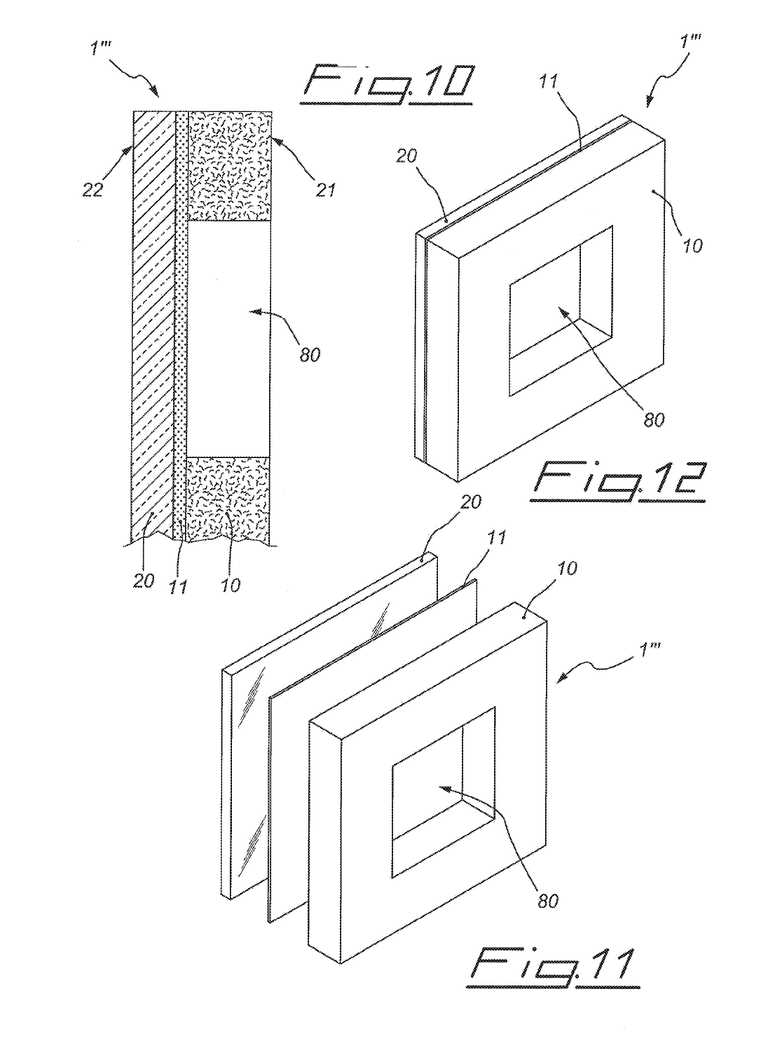

FIGS. 10 to 12 show a further embodiment of a panel according to the present invention indicated with reference 1′″. In this case the first layer 10 is shaped in such a way as to define an opening 80, while the second layer 20 is defined in a manner analogous to what is provided for the first embodiment shown in FIGS. 1 to 3. The second layer 20 could however also be defined by a double-glazing structure. Panel 1′″ is assembled according to methods analogous to the methods described above for panel 1′ shown in FIGS. 1 to 3 and as a function of the type of material constituting the intermediate layer 11 (thermoplastic material, double adhesive, adhesive substance).

1) A multilayer panel comprising a first outer face and a second outer face opposite to said first outer face, characterized in that said panel comprises at least:
a first layer made of cementitious material, said first layer at least partially defining said first outer face of said panel;
a second layer made of a transparent material, said second layer at least partially defining said second outer face;
a first intermediate layer between said first layer and said second layer, said intermediate layer being made of a thermoplastic material which achieves the adhesion of said first layer to said second layer.

2) The panel according to claim 1, wherein said panel comprises a first plurality of inner portions made of transparent material which pass through said first layer.

3) The panel according to claim 2, wherein said inner portions of said first layer develop according to a direction substantially orthogonal to said first outer face of said first layer.

4) The panel according to claim 1, wherein said second layer is made of a glass selected from the group consisting of float base glass, extra-clear glass, low-emissivity laminated glass comprising at least a layer of thermal insulation, laminated glass comprising a reflective insulation layer, laminated glass comprising a layer of safety glass coupled with a low-emissivity glass, tempered glass, decorative glass, screen printed glass and combinations thereof.

5) The panel according to claim 1, wherein said second layer comprises a double-glazing structure comprising a first glass plate, a second glass plate and a perimeter frame interposed between said glass plates so as to define a gap.

6) The panel according to claim 1, wherein said second layer is made of a plastic material transparent to light selected from the group consisting of PMMA, PET, PETG, SAN, PS, PVC and combinations thereof.

7) The panel according to claim 1, wherein said intermediate layer is made of a thermoplastic material selected from the group consisting of polyvinyl butyral (PVB), theintoplastic polyurethane (TPU), ethylene vinyl acetate (EVA) and mixtures thereof.

8) The panel according to claim 1, wherein said first layer defines an opening and wherein a portion of said first outer surface of said panel, corresponding to said opening is defined by said first intermediate layer or by said second layer.

9) A method for the manufacture of a multilayer panel according to claim 1, wherein said method comprises the steps of:
arranging said first layer of cementitious material, said second layer of transparent material and said intermediate layer in a plastic material having a glass transition temperature lower than that of said transparent material of said second layer;
assembling said panel overlaying and pressing together said layers of said panel so as to determine a first union between said layers;
further heating said panel in predetermined pressure conditions, up to a predetermined temperature higher than the glass transition temperature of said transparent thermoplastic material of said first intermediate layer so as to obtain the adhesion of said second layer to said first layer.

10) The method according to claim 9, wherein said first layer is preliminarily defined so that the surface intended to contact said intermediate layer presents a Ra arithmetic average surface roughness lower than 500 nanometres and a curvature lower than 1500 microns.

11) The panel according claim 2, wherein said second layer is made of a glass selected from the group consisting of float base glass, extra-clear glass, low-emissivity laminated glass comprising at least a layer of thermal insulation, laminated glass comprising a reflective insulation layer, laminated glass comprising a layer of safety glass coupled with a low-emissivity glass, tempered glass, decorative glass, screen printed glass and combinations thereof.

12) The panel according to claim 3, wherein said second layer is made of a glass selected from the group consisting of float base glass, extra-clear glass, low-emissivity laminated glass comprising at least a layer of thermal insulation, laminated glass comprising a reflective insulation layer, laminated glass comprising a layer of safety glass coupled with a low-emissivity glass, tempered glass, decorative glass, screen printed glass and combinations thereof.

13) The panel according to claim 2, wherein said second layer comprises a double-glazing structure comprising a first glass plate, a second glass plate and a perimeter frame interposed between said glass plates so as to define a gap.

14) The panel according to claim 3, wherein said second layer comprises a double-glazing structure comprising a first glass plate, a second glass plate and a perimeter frame interposed between said glass plates so as to define a gap.

15) The panel according claim 2, wherein said second layer is made of a plastic material transparent to light selected from the group consisting of PMMA, PET, PETG, SAN, PS, PVC and combinations thereof.

16) The panel according claim 3, wherein said second layer is made of a plastic material transparent to light selected from the group consisting of PMMA, PET, PETG, SAN, PS, PVC and combinations thereof.
